(19) United States
(12) Patent Application Publication
(10) Pub. No.: US 2025/0192136 A1
(43) Pub. Date: Jun. 12, 2025

(54) ELECTRODE FOR LITHIUM SECONDARY BATTERY AND METHOD OF MANUFACTURING THE SAME

(71) Applicant: SK ON CO., LTD., Seoul (KR)

(72) Inventors: Sang Heon SONG, Daejeon (KR); Yoon Sung OH, Daejeon (KR); Dong Hyun LEE, Daejeon (KR)

(21) Appl. No.: 18/951,672

(22) Filed: Nov. 19, 2024

(30) Foreign Application Priority Data
Dec. 11, 2023 (KR) 10-2023-0178210

(51) Int. Cl. H01M 4/04; H01M 4/36; H01M 50/536

(52) U.S. Cl. CPC H01M 4/0435; H01M 4/0404; H01M 4/0471; H01M 4/364; H01M 50/536

(57) ABSTRACT

A method of manufacturing an electrode for a lithium secondary battery comprises a slurry application operation of applying an active material slurry to a coated part excluding an uncoated part disposed at one edge of a current collector, and dividing the current collector into the coated part on which a slurry is applied and the uncoated part on which the slurry is not applied, a heating operation of heating the uncoated part with a heater, a first rolling operation of rolling the coated part with a first rolling roll, and a second rolling operation of rolling the uncoated part with a second rolling roll.

### CROSS-REFERENCE TO RELATED APPLICATION(S)

This patent document claims the priority and benefits of Korean Patent Application No. 10-2023-0178210 filed on Dec. 11, 2023, the disclosure of which is incorporated herein by reference in its entirety.

### TECHNICAL FIELD

The disclosure and implementations disclosed in this patent document generally relate to an electrode for a lithium secondary battery and a method of manufacturing the same.

### BACKGROUND

Unlike primary batteries that cannot be recharged, general secondary batteries are batteries that may be recharged and discharged, and are widely used in electronic devices such as mobile phones, laptop computers and camcorders, and electric vehicles and the like. In detail, lithium secondary batteries have an operating voltage of about 3.6 V, and have a capacity that is about three times that of nickel-cadmium batteries or nickel-hydrogen batteries, which are widely used as power supplies for electronic devices. Since the energy density per unit weight of lithium secondary batteries is high, their utilization is increasing explosively.

In the manufacturing process of secondary batteries, the rolling process may be important in the electrode process to implement high-capacity and high-density battery cells. The rolling process refers to the process of pressing the electrode between a pair of rollers in the electrode process to the target design thickness of the battery cell.

However, in this process, wrinkles and fractures due to partial deformation of the electrode increase, which significantly affects product quality and productivity, and thus improvement is necessary.

### SUMMARY

The present disclosure may be implemented in some embodiments to provide an electrode for a lithium secondary battery, in which an increase in fracture length may be maximized.

The present disclosure may be implemented in some embodiments to provide a method of manufacturing an electrode for a lithium secondary battery with a maximized increase in fracture length.

The present disclosure may be implemented in some embodiments to provide a method of manufacturing an electrode for a lithium secondary battery with increased tensile strength through local heating.

In some embodiments of the present disclosure, a method of manufacturing an electrode for a lithium secondary battery comprises a slurry application operation of applying an active material slurry to a coated part excluding an uncoated part disposed at one edge of a current collector, and dividing the current collector into the coated part on which a slurry is applied and the uncoated part on which the slurry is not applied; a heating operation of heating the uncoated part with a heater; a first rolling operation of rolling the coated part with a first rolling roll; and a second rolling operation of rolling the uncoated part with a second rolling roll.

The uncoated part may comprise a first uncoated part extending from the coated part and a second uncoated part extending from the first uncoated part.

The heating operation may heat the second uncoated part.

The second rolling operation may roll the second uncoated part.

A distance between the second rolling rolls may be 8 to 12 μm.

The method of manufacturing an electrode for a lithium secondary battery may further comprise a welding operation of welding a portion of the second uncoated part rolled in the second rolling operation and connecting the electrode to an electrode tab.

The heater may be a laser heater.

A wavelength of the laser heater may be 600 to 1100 nm.

A length (L1) of the first uncoated part in a direction in which the first uncoated part extends may be 60 to 90% of a total length of the uncoated part.

A length (L2) of the second uncoated part in a direction in which the second uncoated part extends may be 10 to 40% of a total length of the uncoated part.

In some embodiments of the present disclosure, an electrode for a lithium secondary battery comprises a current collector; and an electrode mixture layer disposed on at least one surface of the current collector. The current collector is divided into a coated part on which the electrode mixture layer is disposed and an uncoated part on which the electrode mixture layer is not disposed. An average grain size of the uncoated part measured by an intercept method is 0.1 to 0.5 nm.

An average grain size of the coated part may be 0.01 to 0.1 nm.

The uncoated part may comprise a first uncoated part extending from the coated part and a second uncoated part extending from the first uncoated part.

An average grain size of the second uncoated part may be greater than or equal to an average grain size of the first uncoated part.

An average grain size of the first uncoated part may be greater than or equal to an average grain size of the coated part.

A thickness of the coated part may be greater than or equal to a thickness of the uncoated part.

A thickness of the first uncoated part may be greater than or equal to a thickness of the second uncoated part.

A length (L1) of the first uncoated part in a direction in which the first uncoated part extends may be 60 to 90% of a total length of the uncoated part.

A length (L2) of the second uncoated part in a direction in which the second uncoated part extends may be 10 to 40% of a total length of the uncoated part.

### BRIEF DESCRIPTION OF DRAWINGS

Certain aspects, features, and advantages of the present disclosure are illustrated by the following detailed description with reference to the accompanying drawings.

FIG. 1 is a cross-sectional view of an electrode according to an embodiment.

FIG. 2 is a flow chart illustrating a method of manufacturing an electrode according to an embodiment.

FIG. 3 is a cross-sectional view of an electrode illustrating a heating operation according to an embodiment.

FIG. 4 is a perspective view of an electrode illustrating a heating operation according to an embodiment.

FIG. 5 is a perspective view of an electrode illustrating a rolling operation according to an embodiment.

FIG. 6 is a cross-sectional view illustrating a second uncoated part rolled according to a second rolling operation according to an embodiment.

### DETAILED DESCRIPTION

Features of the present disclosure disclosed in this patent document are described by example embodiments with reference to the accompanying drawings.

Hereinafter, the present disclosure will be described in detail. However, this is merely illustrative and the present disclosure is not limited to the specific embodiments described as examples.

### Electrode for Lithium Secondary Battery

An embodiment is to provide an electrode for a lithium secondary battery, in which an increase in fracture length may be significantly improved, and an embodiment thereof will be described in detail below.

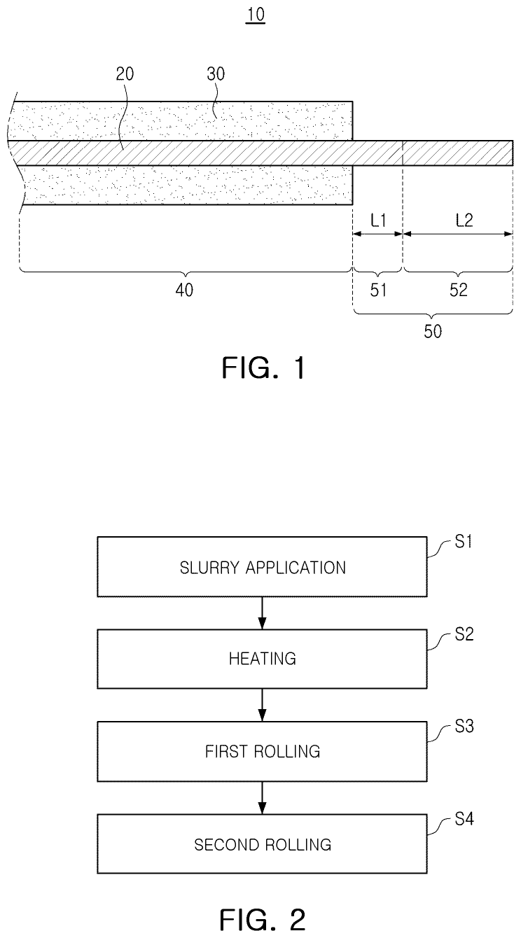

FIG. 1 is a cross-sectional view of an electrode according to an embodiment. Referring to FIG. 1, an electrode for a lithium secondary battery according to an embodiment comprises a current collector 20; and an electrode mixture layer disposed on at least one surface of the current collector 20. The current collector is divided into a coated part 40 on which an electrode mixture layer is disposed and an uncoated part 50 on which an electrode mixture layer is not disposed on the current collector 20. The average crystal grain size of the uncoated part measured according to the intercept method may be 0.1 to 0.5 nm.

Referring to FIG. 1, an electrode 10 according to an embodiment may be comprised in a battery cell. The electrode 10 may be referred to as an “electrode for a lithium secondary battery.” The electrode 10 may be a positive electrode or/and a negative electrode.

The electrode 10 may comprise a current collector 20. The current collector 20 may be referred to as an “electrode current collector.” The current collector 20 may comprise a metal. For example, the current collector 20 may be a metal foil. The current collector 20 may be formed to extend in one direction. For example, the current collector 20 may be formed to extend in the length direction.

The current collector 20 may refer to at least one of a positive current collector and a negative current collector. The positive current collector may be a current collector used in a positive electrode. The negative current collector may be a current collector used in a negative electrode. The current collector 20 may be composed of a metal foil.

The positive current collector may comprise stainless steel, nickel, aluminum, titanium, or alloys thereof. The positive current collector may also comprise aluminum or stainless steel surface-treated with carbon, nickel, titanium, or silver. A thickness of the positive current collector may be, but is not limited to, for example, 5 to 50 μm.

Non-limiting examples of the negative current collector comprise copper foil, nickel foil, stainless steel foil, titanium foil, nickel foam, copper foam, a polymer substrate coated with a conductive metal, and the like. A thickness of the negative current collector may be, but is not limited to, for example, 5 to 50 μm.

The electrode 10 may comprise an electrode mixture layer, and the electrode mixture layer may be an electrode mixture layer manufactured by a slurry 30. A method of manufacturing an electrode mixture layer may be performed by coating/depositing the slurry 30 on the current collector 20 and then drying and rolling the same.

The slurry 30 may be called an “electrode material.” The slurry 30 may be applied to at least one surface of the current collector 20.

The slurry 30 may refer to at least one of a positive electrode slurry and a negative electrode slurry. The positive electrode slurry may comprise an active material for a cathode. The negative electrode slurry may comprise an active material for an anode.

The slurry 30 may be a mixture of an active material, a binder, and a conductive agent. The active material may be classified as an active material for a cathode, used for a positive electrode, and an active material for an anode, used for a negative electrode. The active material may refer to at least one of an active material for a cathode and an active material for an anode.

The positive electrode mixture layer may comprise an active material for a cathode. The active material for a cathode may comprise a compound capable of reversibly intercalating and deintercalating lithium ions.

According to example embodiments, the active material for a cathode may comprise a lithium-nickel metal oxide. The lithium-nickel metal oxide may further comprise at least one of cobalt (Co), manganese (Mn), and aluminum (Al).

In some embodiments, the active material for a cathode or the lithium-nickel metal oxide may comprise a layered structure or a crystal structure represented by the following chemical formula 1.

LiₓNiₐM_{b}O_{2+z} [Chemical Formula 1]

In Chemical Formula 1, 0.9≤x≤1.2, 0.6≤a≤0.99, 0.01≤b≤0.4, and −0.5≤z≤0.1 may be satisfied. As described above, M may comprise Co, Mn, and/or Al.

The chemical structure represented by Chemical Formula 1 represents a bonding relationship comprised in the layered structure or crystal structure of the active material for a cathode and does not exclude other additional elements. For example, M comprises Co and/or Mn, and Co and/or Mn may be provided as the main active element of the active material for a cathode together with Ni. Chemical formula 1 is provided to express the bonding relationship of the main active element and should be understood as encompassing the introduction and substitution of additional elements.

In an embodiment, auxiliary elements may be further comprised in addition to the main active element to enhance the chemical stability of the active material for a cathode or the layered structure/crystal structure. The auxiliary elements may be incorporated together in the layered structure/crystal structure to form a bond, and in this case, it should be understood that they are also comprised within the chemical structure range represented by Chemical Formula 1.

The auxiliary elements may comprise at least one of, for example, Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may act as an auxiliary active element contributing to the capacity/output activity of the active material for a cathode together with Co or Mn, for example, such as Al.

For example, the active material for a cathode or the lithium-nickel metal oxide may comprise a layered structure or a crystal structure represented by the following chemical formula 1-1.

LiₓNiₐM1_{b1}M2_{b2}O_{2+z} [Chemical Formula 1-1]

In Chemical Formula 1, M1 may comprise Co, Mn, and/or Al. M2 may comprise the auxiliary element described above. In Chemical Formula 1-1, 0.9≤x≤1.2, 0.6≤a≤0.99, 0.01≤b1+b2≤0.4, and −0.5≤z≤0.1 may be satisfied.

The active material for a cathode may further comprise a coating element or a doping element. For example, elements substantially identical to or similar to the auxiliary elements may be used as the coating element or the doping element. For example, the elements may be used alone or in combination of two or more as a coating element or doping element.

The coating element or doping element may be present on the surface of the lithium-nickel metal oxide particle, or may penetrate through the surface of the lithium-nickel metal composite oxide particle and be comprised in the bonding structure represented by the chemical formula 1 or chemical formula 1-1.

The active material for a cathode may comprise a nickel-cobalt-manganese (NCM)-based lithium oxide. In this case, an NCM-based lithium oxide with an increased nickel content may be used.

Ni may be provided as a transition metal associated with the output and capacity of a lithium secondary battery. Therefore, by employing a high-Ni composition in the active material for a cathode as described above, a high-capacity positive electrode and a high-capacity lithium secondary battery may be provided.

However, as the Ni content increases, the long-term storage stability and lifespan stability of the positive electrode or secondary battery may be relatively reduced, and side reactions with the electrolyte may also increase. However, according to example embodiments, by comprising Co, electrical conductivity may be maintained, while life stability and capacity retention characteristics may be improved through Mn.

The content of Ni (for example, the mole fraction of nickel among the total moles of nickel, cobalt, and manganese) in the NCM-based lithium oxide may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the active material for a cathode may comprise a lithium cobalt oxide-based active material, a lithium manganese oxide-based active material, a lithium nickel oxide-based active or a lithium material, ferrophosphate (LFP)-based active material (for example, LiFePO₄).

In some embodiments, the active material for a cathode may comprise, for example, a Mn-rich active material, an Li rich layered oxide (LLO)/Over Lithiated Oxide (OLO) active material or a Co-less active material having a chemical structure or crystal structure represented by Chemical Formula 2.

p[Li₂MnO₃]·(1−p)[Li_{q}JO₂] [Chemical Formula 2]

In Chemical Formula 2, 0<p<1 and 0.9≤q≤1.2 may be satisfied, and J may comprise at least one element among Mn, Ni, Co, Fe, Cr, V, Cu, Zn, Ti, Al, Mg, and B.

Non-limiting examples of solvents used in the preparation of the positive electrode mixture layer may comprise N-methyl-2-pyrrolidone (NMP), dimethylformamide, dimethylacetamide, N, N-dimethylaminopropylamine, ethylene oxide, tetrahydrofuran, and the like.

The binder may comprise polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR), or the like. In an embodiment, a PVDF series binder may be used as the positive electrode binder.

The conductive material may be added to enhance the conductivity of the positive electrode mixture layer and/or the mobility of lithium ions or electrons. For example, the conductive material may comprise, but is not limited to, a carbon-based conductive material such as graphite, carbon black, acetylene black, Ketjen black, graphene, carbon nanotubes, vapor-grown carbon fiber (VGCF), carbon fiber, or the like and/or a metal-based conductive material comprising a perovskite material such as LaSrCoO₃, LaSrMnO₃, tin, tin oxide, titanium oxide, or the like.

If necessary, the positive electrode mixture layer may further comprise a thickener and/or a dispersant, or the like. In an embodiment, the positive electrode mixture layer may comprise a thickener such as carboxymethyl cellulose (CMC).

The negative electrode mixture layer may comprise an active material for an anode. A material capable of adsorbing and desorbing lithium ions may be used as the active material for an anode. For example, the active material for an anode may be a carbon-based material such as crystalline carbon, amorphous carbon, carbon composite, carbon fiber, or the like; lithium metal; lithium alloy; a silicon (Si)-containing material, tin (Sn)-containing material, or the like.

Examples of the amorphous carbon may comprise hard carbon, soft carbon, coke, mesocarbon microbeads (MCMB), mesophase pitch-based carbon fibers (MPCF), and the like.

Examples of the crystalline carbon may comprise graphite-based carbons such as natural graphite, artificial graphite, graphitized coke, graphitized MCMB, and graphitized MPCF.

The lithium metal may comprise pure lithium metal or lithium metal having a protective layer formed thereon for suppressing dendrite growth or the like. In an embodiment, a lithium metal-containing layer deposited or coated on a negative electrode current collector may be used as an anode active material layer. In an embodiment, a lithium thin film layer may be used as an anode active material layer.

Elements comprised in the lithium alloy may comprise aluminum, zinc, bismuth, cadmium, antimony, silicon, lead, tin, gallium, indium, or the like.

The silicon-containing material may provide relatively increased capacity characteristics. The silicon-containing material may comprise Si, SiOx (0<x<2), metal-doped SiOx (0<x<2), silicon-carbon composites, or the like. The metal may comprise lithium and/or magnesium, and the metal-doped SiOx (0<x<2) may comprise metal silicate.

Non-limiting examples of solvents for the negative electrode mixture layer comprise water, pure water, deionized water, distilled water, ethanol, isopropanol, methanol, acetone, n-propanol, t-butanol, and the like.

The above-described materials that may be used in the manufacture of the positive electrode may be used as the binder, the conductive agent, and the thickener.

In some embodiments, a styrene-butadiene rubber (SBR)-based binder, carboxymethyl cellulose (CMC), a polyacrylic acid-based binder, a poly(3,4-ethylenedioxythiophene, PEDOT)-based binder, or the like may be used as the negative electrode binder.

The electrode 10 may be divided or partitioned into an area where the slurry 30 is applied to the current collector 20 and the remaining area. For example, the current collector 20 may comprise a coated part 40 and an uncoated part 50.

The coated part 40 may refer to a portion of the current collector 20 where the slurry 30 is applied to the current collector 20, and may refer to a portion of the current collector 20 where an electrode mixture layer formed of the slurry 30 is disposed.

The uncoated part 50 may refer to a portion of the current collector 20 where the slurry 30 is not applied. For example, the uncoated part 50 may refer to a portion of the electrode 10 excluding the coated part 40. The coated part 40 and the uncoated part 50 may be disposed in the length direction of the current collector 20.

A portion of the uncoated part 50 may be cut as a cut portion, and the remaining part may be connected or joined to the electrode tab through welding, with the cut part removed. In this manner, the electrode 10 and the electrode tab may be connected or combined.

The electrode for a secondary battery in the present disclosure may comprise the uncoated part 50 having a specific average grain size, thereby significantly reducing a decrease in tensile strength and increasing the elongation, and thus suppressing occurrence of fracture of the uncoated part.

The average grain size may be measured by the intercept method. The measurement method using an intercept method may be performed by the following equation 1.

$$D = 1 / ( n \times M ) \qquad [ Equation 1 ]$$

In Equation 1, D represents the average grain size, 1 represents the length of a straight line arbitrarily drawn on the grain, represents the average number of intersections of the straight line 1 and the grain boundary, and M represents a magnification. The 1 and n values may be measured through images taken by SEM, and M may refer to the magnification of the SEM image.

The average grain size of the uncoated part 50 may be 0.1 to 0.5 nm, in detail, 0.1 to 0.4 nm, and in more detail, 0.15 to 0.4 nm. If the average grain size of the uncoated part 50 is less than 0.1 nm, sufficient elongation characteristics cannot be secured, and thus fracture may occur in the uncoated part 50, and if exceeding 0.5 nm, the tensile strength may be reduced. In this case, when the uncoated part 50 is divided into multiple regions, the average grain size of the uncoated part 50 may mean that the average grain size of each region is comprised in the above-described range.

The grain size of the coated part 40 may be 0.01 to 0.1 nm, and in detail, 0.01 to 0.06 nm. When the grain size of the coated part 40 has a size within the range, the tensile strength of the battery may be increased.

In detail, the uncoated part 50 may comprise a first uncoated part 51 and a second uncoated part 52. The first uncoated part 51 may be connected to the coated part 40. The second uncoated part 52 may be spaced apart from the coated part 40. The first uncoated part 51 may be disposed between the coated part 40 and the second uncoated part 52. The first uncoated part 51 may connect the coated part 40 and the second uncoated part 52.

The first uncoated part 51 may be formed by extending from the coated part 40, and the second uncoated part 52 may be formed by extending from the first uncoated part 51. The second uncoated part 52 may be coupled to an electrode tab. Through heat treatment by a heating process described below, the tensile strength of the uncoated part 50 may be sequentially reduced from the first uncoated part 51 toward the second uncoated part 52.

The average grain size of the second uncoated part 52 may be greater than or equal to the average grain size of the first uncoated part 51. When the average grain size of the second uncoated part 52 is greater than or equal to the average grain size of the first uncoated part 51, the crack stability of the particle may be increased and the tensile strength of the battery may be increased.

The average grain size of the first uncoated part 51 may be greater than or equal to the average grain size of the coated part 40. When the average grain size of the first uncoated part 51 is greater than or equal to the average grain size of the coated part 40, the crack stability of the particle may be increased and the tensile strength of the battery may be increased.

Referring to FIG. 1, the lengths of the first uncoated part 51 and the second uncoated part 52 may be L1 and L2, respectively. L1 may refer to the length of the first uncoated part 51 in the direction in which the first uncoated part 51 extends, and L2 may refer to the length of the second uncoated part 52 in the direction in which the second uncoated part 52 extends.

The total length of the uncoated part 50 may be 50 mm or less, L1 may be 60 to 90% of the total uncoated part 50, and L2 may be 10 to 40% of the total uncoated part 50.

### Method of Manufacturing Electrode for Lithium Secondary Battery

An embodiment is to provide an electrode for a lithium secondary battery, in which an increase in fracture length may be maximized and a decrease in tensile strength may be minimized due to local heating, and an embodiment is described in detail below.

FIG. 2 is a flow chart illustrating a method of manufacturing an electrode according to an embodiment. Referring to FIG. 2, a method of manufacturing an electrode for a lithium secondary battery, which is an embodiment, may comprise a slurry application operation (S1) of applying an active material slurry 30 on a coated part 40 excluding an uncoated part disposed at one edge of a current collector 20, thereby dividing the current collector 20 into a coated part 40 on which the slurry 30 is applied and an uncoated part 50 on which the slurry 30 is not applied; a heating operation (S2) of heating the uncoated part 50 with a heater 60; a first rolling operation (S3) of rolling the coated part 40 with a first rolling roll 71; and a second rolling operation (S4) of rolling the uncoated part 50 with a second rolling roll 72.

In the slurry application operation (S1), the slurry 30 may be applied to at least one surface of the current collector 20. The current collector 20 and the slurry 30 may be the same as the current collector 20 and the slurry 30 described above in the lithium secondary battery electrode, respectively. Depending on the slurry application operation (S1), the current collector may be divided into the coated part 40 and the uncoated part 50. In addition, the uncoated part may comprise a first uncoated part 51 extending from the coated part 40 and a second uncoated part 52 extending from the first uncoated part 51.

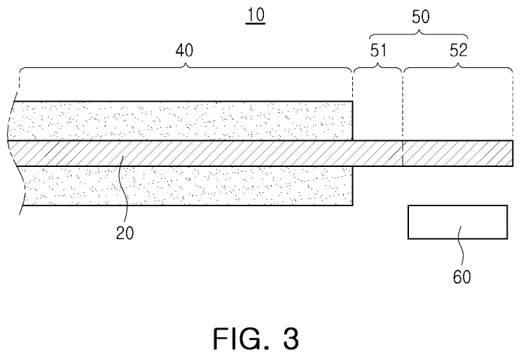

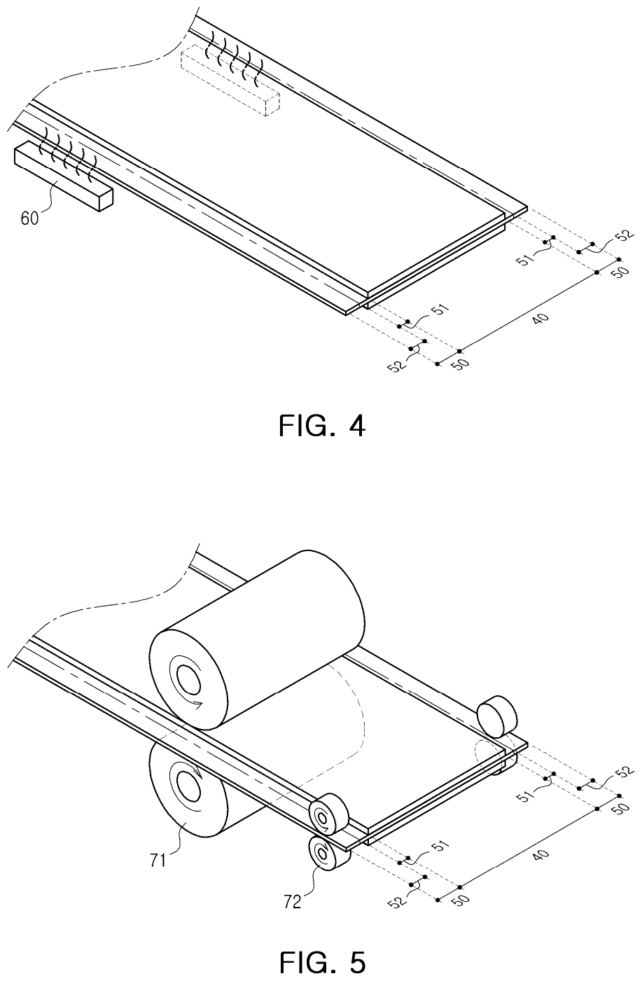

FIG. 3 is a cross-sectional view of an electrode illustrating a heating operation (S2) according to an embodiment, and FIG. 4 is a perspective view of an electrode illustrating a heating operation (S2) according to an embodiment. Referring to FIGS. 3 and 4, an embodiment may comprise the heating operation (S2).

The heating operation (S2) may be an operation of heating the uncoated part 50 with the heater 60. The heater 60 may be a laser heater, and the type of the laser heater is not particularly limited, but, for example, a YAG, a diode, a green laser, a blue laser, or the like may be used.

When using a laser heater as the heater 60, only the part where heating is desired may be intensively and locally heated, so that the temperature increase in the surrounding area excluding the uncoated part 50 may be minimal, and the tensile strength of the electrode may be prevented from decreasing.

The wavelength of the laser heater may be 600 to 1100 nm, the output of the laser may be 500 to 5000 W, and the laser output time may be 1 second or less. The laser output may be continuously oscillated in a roll-to-roll facility.

The heating operation (S2) may be an operation of heating the second uncoated part 52 in the uncoated part 50. By locally heating the second uncoated part 52, only a portion of the second uncoated part 52 may be implemented to have a tensile strength decrease and an elongation increase, thereby significantly reducing the tensile strength decrease while enhancing the fracture prevention characteristics of the rolling process.

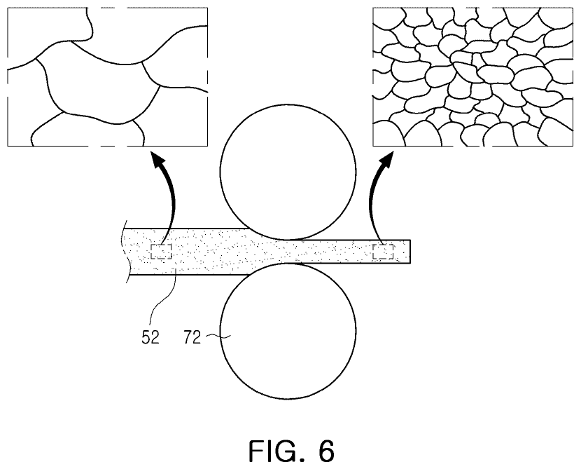

FIG. 5 is a perspective view of an electrode illustrating a rolling operation according to an embodiment. Referring to FIG. 5, an embodiment may comprise a rolling operation, and the rolling operation may comprise two or more rolling operations comprising a first rolling operation (S3) and a second rolling operation (S4).

The first rolling operation (S3) may be an operation of rolling the coated part 40 with a first rolling roll 71. The first rolling operation (S3) may be an operation of pressing the electrode 10 to which the slurry 30 is applied so that the density of the dried slurry 30 increases. The electrode 10 may be pressed to a set thickness according to the first rolling operation (S3).

The distance between the first rolling rolls 71 may be 80 to 180 μm. When the coated part 40 is passed between the first rolling rolls 71 having the distance range, the thickness of the coated part 40 may be 100 to 200 μm. When the coated part 40 has the thickness in the range, the designed electrode energy density may be obtained.

The second rolling operation (S4) may be an operation of rolling the uncoated part 50 with the second rolling roll 72. The second rolling operation (S4) may reduce the metal crystal grain size and increase the tensile strength by plastically deforming the current collector of the uncoated part 50.

In addition, the second rolling operation (S4) may increase the tensile strength of the uncoated part 50 having been relatively reduced according to the heating operation (S2).

FIG. 6 is a cross-sectional view illustrating the uncoated part 50 rolled according to the second rolling operation (S4) according to an embodiment. Referring to FIG. 6, it can be confirmed that the grain size of the uncoated part 50 decreases after rolling the uncoated part 50 with the second rolling roll 72 according to the second rolling operation (S4). As the grain size of the uncoated part 50 decreases due to the rolling, the tensile strength of the battery may be increased.

The distance between the second rolling rolls 72 may be 8 to 12 μm. When the second uncoated part 52 is passed between the second rolling rolls 72 having the range, the thickness of the second uncoated part 52 may become 10 to 12 μm. When the second uncoated part 52 has a thickness within this range, plastic deformation of the current collector particles may occur, and the metal grain size may decrease due to the plastic deformation, thereby increasing the tensile strength of the battery.

The second rolling operation (S4) may be an operation of rolling the second uncoated part 52. When the second uncoated part 52 is locally heated in the heating operation (S2), the tensile strength of the second uncoated part 52, which has been relatively reduced, may be increased.

The crystal grain size may be measured through the intercept method, and the detailed measurement method may be the same as the measurement method using the intercept method described above.

For the second uncoated part rolled in the second rolling operation (S4), a welding operation may be further comprised, and a portion of the second uncoated part 52 may be cut by the welding operation. In the second uncoated part 52, from which the cut portion has been removed, the remaining portion may be connected or joined to the electrode tab through welding. Therefore, the electrode 10 and the electrode tab may be connected.

The welding method is not particularly limited, but may be performed according to the ultrasonic welding method.

### EXAMPLE

Hereinafter, embodiments will be further described with reference to detailed experimental examples. The examples and comparative examples comprised in the experimental examples are merely illustrative of the present disclosure and do not limit the scope of the appended claims. It will be apparent to those skilled in the art that various changes and modifications to the examples are possible within the scope and technical idea of the present disclosure, and it is also natural that such modifications and variations fall within the scope of the appended claims.

### Manufacturing Example

### Example 1

A positive electrode slurry was applied on an Al current collector to form a coated part and an uncoated part separately. A second uncoated part corresponding to the end of the uncoated part from 80% of the length (L1) in the direction in which the uncoated part extends from the coated part was heated with a laser heater for 0.0375 seconds. The laser wavelength of the laser heater was 1068 nm.

Then, the electrode was rolled with the first rolling rolls that have a gap of 90 μm therebetween, and then the second uncoated part was rolled with the second rolling rolls that have a gap of 5 μm therebetween to manufacture an electrode for a lithium secondary battery.

### Comparative Example 1

Except that local heating and second rolling were not performed, an electrode for a lithium secondary battery was manufactured in the same manner as in Example 1.

### Comparative Example 2

Except that the operation of rolling with the second rolling roll was not performed, an electrode for a lithium secondary battery was manufactured in the same manner as in Example 1.

### Evaluation Example

### 1. Measurement of Grain Size

The grain sizes of the coated part, the first uncoated part, and the second uncoated part of Example 1 and Comparative Examples 1 and 2 were measured 10 times each according to the intercept method, and the average grain size thereof was measured, which is illustrated in Table 1 below.

TABLE 1

| | Average Grain Size (nm) | | |
|---|---|---|---|
| | | First Uncoated | Second Uncoated |
| | Coated Part | Part | Part |
| Example 1 | 0.0640 | 0.1684 | 0.3200 |
| Comparative | 0.0640 | 0.0640 | 0.0640 |
| Example 1 | | | |
| Comparative | 0.0640 | 0.3175 | 0.5195 |
| Example 2 | | | |

### 2. Thickness Measurement

The average thicknesses of the electrodes of Example 1 and Comparative Examples 1 and 2 were measured through cross-sectional analysis using SEM, and the results are illustrated in Table 2 below.

TABLE 2

| | Average Thickness (μm) | | |
|---|---|---|---|
| | | First Uncoated | Second Uncoated |
| | Coated Part | Part | Part |
| Example 1 | 11.725 ± 0.245 | 11.325 ± 0.115 | 10.995 ± 0.215 |
| Comparative | 11.555 ± 0.115 | 11.555 ± 0.115 | 11.555 ± 0.115 |
| Example 1 | | | |
| Comparative | 11.89 ± 0.11 | 12.195 ± 0.105 | 12.135 ± 0.065 |
| Example 2 | | | |

### 3. Tensile Strength Comparison (Fracture Measurement)

The tensile strength of the coated part, the first uncoated part, and the second uncoated part of Example 1 and Comparative Examples 1 an 2 was measured using UTM, and the number of breaks was measured while performing a 500 m press using Roll to Roll equipment, which is illustrated in Table 3 below.

TABLE 3

| | Tensile Strength (kgf/mm²) | | | Number of |
|---|---|---|---|---|
| | | First | Second | Fractures |
| | Coated | Uncoated | Uncoated | (rolled at |
| | Part | Part | Part | 500m) |
| Example 1 | 26.5 | 15.4 | 14.4 | 0 times |
| Comparative | 26.5 | 26.5 | 26.5 | 30 times |
| Example | | | | or more |
| 1 | | | | |
| Comparative | 26.5 | 9.2 | 7.4 | 0 times |
| Example | | | | |
| 2 | | | | |

Referring to Tables 1 to 3 above, it can be confirmed that the lithium secondary battery of Example 1 has a higher tensile strength than that in Comparative Example 2, in which the second rolling was not performed. Comparative Example 1 has a small crystal grain size, but it can be confirmed that it is fractured because the elongation does not increase due to the local heating process not being performed.

Comparative Example 2 did not perform the second rolling, and the average crystal grain size of the first uncoated part is small, but the average crystal grain size of the second uncoated part is large, and it can be confirmed that sufficient tensile strength is not secured, so that sticking occurs when welding between electrodes in the subsequent process.

The contents described above are merely examples of applying the principles of the present disclosure, and other configurations may be further comprised without departing from the scope of the present disclosure.

As set forth above, in an electrode for a lithium secondary battery according to an embodiment, an increase in fracture length may be maximized.

A method of manufacturing an electrode for a lithium secondary battery according to an embodiment may maximize an increase in fracture length.

A method of manufacturing an electrode for a lithium secondary battery according to an embodiment may significantly reduce a decrease in tensile strength due to local heating.

Only specific examples of implementations of certain embodiments are described. Variations, improvements and enhancements of the disclosed embodiments and other embodiments may be made based on the disclosure of this patent document.

What is claimed is:

1. A method of manufacturing an electrode for a lithium secondary battery, the method comprising:
a slurry application operation of applying an active material slurry to a coated part excluding an uncoated part disposed at an edge of a current collector, and dividing the current collector into the coated part on which a slurry is applied and the uncoated part on which the slurry is not applied;
a heating operation of heating the uncoated part with a heater;
a first rolling operation of rolling the coated part with a first rolling roll; and
a second rolling operation of rolling the uncoated part with a second rolling roll.

2. The method of claim 1, wherein the uncoated part comprises a first uncoated part extending from the coated part and a second uncoated part extending from the first uncoated part.

3. The method of claim 2, wherein the heating operation heats the second uncoated part.

4. The method of claim 2, wherein the second rolling operation rolls the second uncoated part.

5. The method of claim 2, wherein a distance between the second rolling rolls is 8 to 12 μm.

6. The method of claim 2, further comprising a welding operation of welding a portion of the second uncoated part rolled in the second rolling operation and connecting the electrode to an electrode tab.

7. The method of claim 1, wherein the heater is a laser heater.

8. The method of claim 7, wherein a wavelength of the laser heater is 600 to 1100 nm.

9. The method of claim 2, wherein a length (L1) of the first uncoated part in a direction in which the first uncoated part extends is 60 to 90% of a total length of the uncoated part.

10. The method of claim 2, wherein a length (L2) of the second uncoated part in a direction in which the second uncoated part extends is 10 to 40% of a total length of the uncoated part.

11. An electrode for a lithium secondary battery, comprising:
a current collector; and
an electrode mixture layer disposed on at least one surface of the current collector,
wherein the current collector is divided into a coated part on which the electrode mixture layer is disposed and an uncoated part on which the electrode mixture layer is not disposed, and
wherein an average grain size of the uncoated part measured by an intercept method is 0.1 to 0.5 nm.

12. The electrode of claim 11, wherein an average grain size of the coated part is 0.01 to 0.1 nm.

13. The electrode of claim 11, wherein the uncoated part comprises a first uncoated part extending from the coated part and a second uncoated part extending from the first uncoated part.

14. The electrode of claim 13, wherein an average grain size of the second uncoated part is greater than or equal to an average grain size of the first uncoated part.

15. The electrode of claim 13, wherein an average grain size of the first uncoated part is greater than or equal to an average grain size of the coated part.

16. The electrode of claim 11, wherein a thickness of the coated part is greater than or equal to a thickness of the uncoated part.

17. The electrode of claim 13, wherein a thickness of the first uncoated part is greater than or equal to a thickness of the second uncoated part.

18. The electrode of claim 13, wherein a length (L1) of the first uncoated part in a direction in which the first uncoated part extends is 60 to 90% of a total length of the uncoated part.

19. The electrode of claim 13, wherein a length (L2) of the second uncoated part in a direction in which the second uncoated part extends is 10 to 40% of a total length of the uncoated part.
